(19) United States
(12) Patent Application Publication
(10) Pub. No.: US 2025/0385868 A1
(43) Pub. Date: Dec. 18, 2025

(54) LOAD BALANCER AND SHUFFLE SHARDING FOR CLOUD-HOSTED SERVICES

(71) Applicant: Stripe Inc., South San Francisco, CA (US)

(72) Inventors: Robert Perez, South San Francisco, CA (US); Nalin Goel, South San Francisco, CA (US)

(21) Appl. No.: 18/746,013

(22) Filed: Jun. 17, 2024

(51) Int. Cl. H04L 47/125; H04L 43/062; H04L 47/122

(52) U.S. Cl. CPC H04L 47/125; H04L 43/062; H04L 47/122

(57) ABSTRACT

Embodiments include hardware and software resources of a distributed computing system for routing user data traffic to computing resources organized using a shuffle sharding arrangement. Layer 3 (L3) network load balancers proxy or route user data traffic requests to layer 4 (L4) transport load balancers. A L4 transport load balancer proxies and routes the requests to certain ingress cells that are assigned or mapped to the hosted computing services of the user requests according to proxy or routing functions and mapping data. The assignments between cells and computing services may be implemented by a cell manager program when onboarding the computing services in accordance with the shuffle sharding arrangement and configuration. The transport load-balancer may impose and enforce the shuffle sharding by routing user data to ingress cells assigned to the computing services using previously determined mappings data stored in a mappings database (or data file).

### TECHNICAL FIELD

This application generally relates to systems and methods for hosting cloud-based services, including provisioning multi-tenant clustered resources and dynamically routing data traffic amongst resources in a multi-layered proxied architecture.

### BACKGROUND

Cloud infrastructure providers and systems, such as Microsoft Azure® and Amazon Web Services® (AWS®), operate various cloud hosting systems, which provision clusters of computing resources for hosting various networking functions and webservices on behalf of enterprise service provider systems. The cloud infrastructure provider enables the service provider to offer user-facing functionality over the Internet. The cloud infrastructure provider provisions various computing resources to the service provider system to manage and operate, including hardware, software, and virtualized computing resources, among other types of resources, often provisioned to operate in virtualized resources or virtual machines that operate and communicate at layer 7 (L7) of the OSI model.

In some cases, the cloud-hosting infrastructure system offers various services or products in addition to the hosting services, which the service provider can select and deploy into the cloud-hosted environment provisioned to the service provider. These additional services or produces may perform various operations for data networking operations, communication security, performance optimization, and load-balancing, among others. Although such features offered by the cloud-hosting systems are frequently deployed and often beneficial, such features and service offerings have some problems or inefficiencies that may not serve the needs of the service provider's enterprise system.

For instance, these add-on services are oftentimes too opaque or inflexible, which lacks the configurable flexibility of the resources to meet the needs of increasing workload within the service provider system. As an example, conventional network routing functions operate according to the various layers of the OSI model, which often includes network load balancing functions that operate at layer 3 (L3) and/or layer 4 (L4). A problem, however, is that conventional add-on network load balancing functions that operate at layer 3, while the computing resources provisioned to the service provider architecture are virtualized resources or virtual machines that operate as layer 7 applications. The service provider's architecture would have no access to telemetry information related to the layer 3 or layer 4 routing actions.

As another example, during DDOS attacks, a layer 3 security service (e.g., AWS Shield®) may detect and drop packets of data traffic, without capturing and providing any telemetry information that could be useful to the service provider to detect bad actors or nuance future data traffic according to certain patterns. Rather, conventional security services or network load balancers typically drop suspicious or malicious traffic indiscriminately (both good and bad). For instance, the conventional security services or network load balancers may simply drop traffic exceeding beyond a threshold amount of requests (e.g., 20 k requests per second (RPS)) during a SYN flood attack, even if the traffic includes acceptable data traffic. In such conventional approaches, when the computing resources hosting a computing service being attacked and suffering a DDOS event, the DDOS event attacking the computing service could impact other computing services hosted on the same infrastructure, resulting in “noisy neighbor” problems.

### SUMMARY

Disclosed herein are systems and methods capable of addressing the above-described shortcomings and may also provide any number of additional or alternative benefits and advantages. Embodiments include systems and methods for improving implementations of shuffle sharding to improve upon resource isolation, load balancing, and mitigating against DDOS attacks.

In embodiments, a computer-implemented method for managing data traffic. The method comprises receiving, by a computer executing a load-balancer program, client data traffic comprising one or more data packets that originated at a client device; determining, by the computer, a destination domain hosting one or more webservices requested by the client data traffic according to header data of the one or more data packets; querying, by the computer, a mapping database using the destination domain to identify a set of ingress host cells assigned to the destination domain, the mapping database containing mapping data indicating a plurality of mappings between a plurality of domains to a plurality of sets of ingress host cells; and routing, by the computer, the one or more data packets of the data traffic to an ingress host of the set of ingress host cells assigned to the destination domain according to the mapping data.

In some implementations, each ingress host of each ingress host cell routes the data traffic to the destination domain.

In some implementations, the method may include establishing, by the computer, a transport-layer connection for the client device to the ingress host of the sets of ingress host cells according to the mapping data.

In some implementations, the method may include updating, by the computer, one or more header fields of at least one data packet of the client data traffic for routing the client data traffic to the ingress host and to the destination domain.

In some implementations, the method may include determining, by the computer, health check information for each ingress host cell assigned to the destination domain using the mapping database.

In some implementations, the method may include querying, by the computer, a cell manager program that polls each instance of the ingress host cells associated with the destination domain; and receiving, by the computer, the health check information from the cell manager program.

In some implementations, the method may include assigning, by the computer, the one or more webservices of the destination domain to at least one ingress cell during an onboarding process; and updating, by the computer, the mapping database to indicate that the one or more webservices are mapped to the at least one ingress cell.

In some implementations, the method may include determining, by the computer, a service name indicator (SNI) in the header data of at least one data packet of the client data traffic. The SNI indicates the destination domain of the client data traffic.

In some implementations, the set of ingress host cells assigned to the destination domain includes a set of quarantine ingress cells. The computer may route the client data traffic to the set of quarantine ingress cells in response to the computer determining that the client data traffic satisfies one or more quarantine thresholds.

In some implementations, the method may include obtaining, by the computer, packet telemetry data for the client data traffic using the header data of the one or more data packets of the client data traffic.

In some embodiments, a system for managing data traffic. The system comprises a mapping database comprising non-transitory machine-readable storage media, configured to store mapping data indicating a plurality of mappings between a plurality of domains to a plurality of sets of ingress host cells. The system may further include a computing device comprising at least one processor and a load-balancer program. The computing device may be configured to: receive client data traffic comprising one or more data packets that originated at a client device; determine a destination domain hosting one or more webservices requested by the client data traffic according to header data of the one or more data packets; query the mapping database using the destination domain to identify a set of ingress host cells assigned to the destination domain; and route the one or more data packets of the data traffic to an ingress host of the set of ingress host cells assigned to the destination domain according to the mapping data.

In some implementations, each ingress host of each ingress host cell routes the data traffic to the destination domain.

In some implementations, the computing device is further configured to establish a transport-layer connection for the client device to the ingress host of the sets of ingress host cells according to the mapping data.

In some implementations, the computing device is further configured to update one or more header fields of the header data of at least one data packet of the client data traffic for routing the client data traffic to the ingress host and to the destination domain.

In some implementations, the computing device is further configured to determine health check information for each ingress host cell assigned to the destination domain using the mapping database.

In some implementations, the computing device is further configured to: query a cell manager program that polls each instance of the ingress host cells associated with the destination domain; and receive the health check information from the cell manager program.

In some implementations, the computing device is further configured to: assign the one or more webservices of the destination domain to at least one ingress cell during an onboarding process; and update the mapping database to indicate that the one or more webservices are mapped to the at least one ingress cell.

In some implementations, the computing device is further configured to determine a service name indicator (SNI) in the header data of at least one data packet of the client data traffic. The SNI indicates the destination domain of the client data traffic.

In some implementations, the set of ingress host cells assigned to the destination domain includes a set of quarantine ingress cells. The computer may route the client data traffic to the set of quarantine ingress cells in response to the computer determining that the client data traffic satisfies one or more quarantine thresholds.

In some implementations, the computing device is further configured to obtain packet telemetry data for the client data traffic using the header data of the one or more data packets of the client data traffic.

It is to be understood that both the foregoing general description and the following detailed description are exemplary and explanatory and are intended to provide further explanation of the invention as claimed.

### BRIEF DESCRIPTION OF THE DRAWINGS

The present disclosure can be better understood by referring to the following figures. The components in the figures are not necessarily to scale, emphasis instead being placed upon illustrating the principles of the disclosure. In the figures, reference numerals designate corresponding parts throughout the different views.

FIGS. 1A-1B show components of a system for handling data traffic for various computing services and web-based applications in a distributed computing environment, according to an example embodiment.

FIG. 2 shows data flow amongst components of a provider system implementing shuffle-sharding at an edge of the provider system, according to an example embodiment.

FIG. 3 shows operations of a method for handling user data traffic in a distributed computing environment of a provider system implementing shuffle sharding, according to an example embodiment.

FIG. 4 is a component diagram of an example computing system suitable for use in the various implementations described herein, according to an example embodiment.

### DETAILED DESCRIPTION

Reference will now be made to the illustrative embodiments illustrated in the drawings, and specific language will be used here to describe the same. It will nevertheless be understood that no limitation of the scope of the invention is thereby intended. Alterations and further modifications of the inventive features illustrated here, and additional applications of the principles of the inventions as illustrated here, which would occur to a person skilled in the relevant art and having possession of this disclosure, are to be considered within the scope of the invention.

Embodiments include systems and methods for handling data traffic across clusters of computing resources in a distributed cloud-computing system and environment. A service provider system (e.g., online web application service providers, banking service providers, education service providers, government agencies) is logically and physically, organized and configured into various clusters of computing resources within a distributed computing system. Generally, a “cluster” includes a collection of related computing resources, such as servers or virtual machines, working together to perform computing tasks of various computing services or applications hosted by the hardware and software of the provider system. The clusters may be implemented to, for example, improve performance by distributing workloads across multiple computing resources or provide high availability by provisioning clusters having redundant computing resources, among other benefits. It should be appreciated that, in some embodiments, the service provider system is hosted within a cloud hosting infrastructure system (e.g., Azure®, AWS®), though the service provider need not employ a cloud infrastructure system to host the service provider system.

Embodiments may implement shuffle sharding for provisioning and isolating the computing resources of an architecture of the service provider system and/or the cloud-hosting system. “Shuffle sharding” is a networking architecture technique employed for hosting and deploying various types of networking services (e.g., AWS Global Accelerator® services, Route53® domain services) of a distributed computing system, such as the service provider system or cloud-hosting infrastructure systems (e.g., Azure®, AWS®). In the distributed computing environment, the shuffle sharding technique may be implemented to distribute and “shard” various types of data or instructions across multiple nodes or servers of the provider system to improve performance, scalability, and fault tolerance. In some implementations, shuffle sharding may be performed by, for example, a distributed database or management software component of a data-processing framework, such as Apache Hadoop®, Apache Spark®, or other similar distributed computing platforms.

Shuffle sharding creates isolations in a multi-tenant architecture to reduce the likelihood of a hosted computing service impacting another computing service. The management software program provisions and isolates the computing services by “sharding” the service provider's architecture into cells and assigning randomly multiple overlapping cells to individual computing services of the service provider (e.g., security services, payment services). If the cells of a computing service are down or unavailable, there is a high probability that the computing services still have at least one cell to which the service provider system can route data traffic. In the context of shuffle sharding, a “cell’ may refer to a logical or physical unit of various computing resources within the distributed computing framework or system responsible for managing and coordinating certain functions or computing services, such as executing networking services, application services, or routing data traffic, among other functions.

Embodiments disclosed herein include various functions and features for implementing shuffle sharding in the service provider system. The service provider system includes a typical layer 3 (L3) network load balancer that proxies or routes data traffic requests to a layer 4 (L4) transport load balancer. Computing devices functioning as hosts or nodes of the L4 load balancer include software implementing the shuffle sharding logic, instructing the L4 load balancer on proxying the requests to certain ingress cells that are assigned or mapped to the computing services of the user requests according to proxy or routing functions and mapping data. The assignments between cells and computing services may be implemented by a cell manager program when onboarding the computing services in accordance with the shuffle sharding arrangement and configuration. The transport load-balancer may impose and enforce the shuffle sharding by routing user data to ingress cells assigned to the computing services using previously determined mappings data stored in a mappings database (or data file).

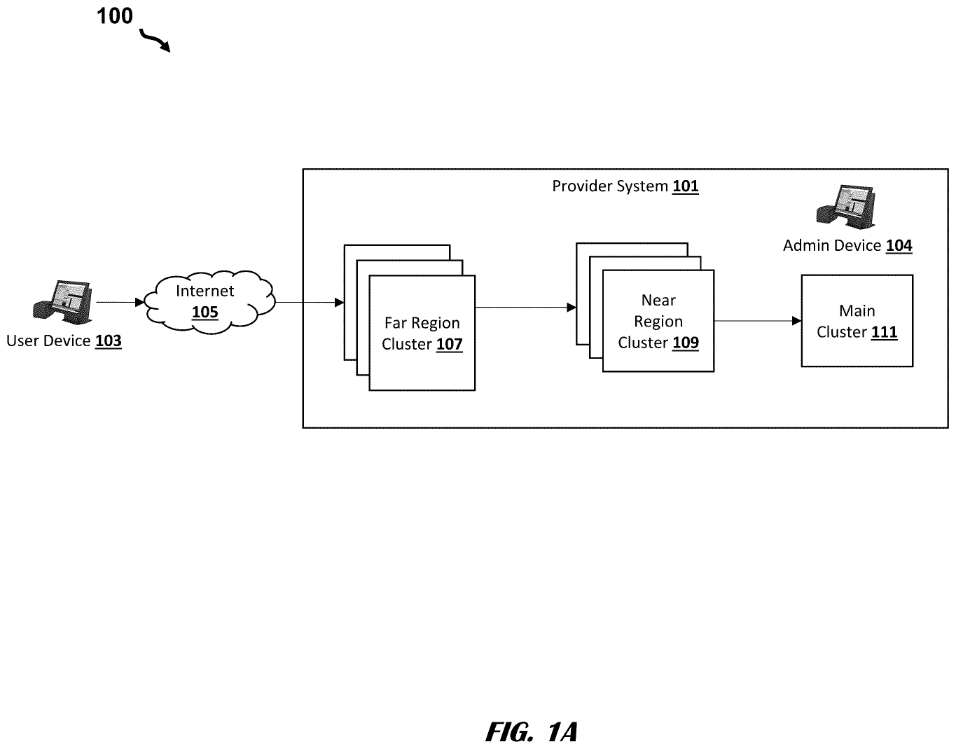

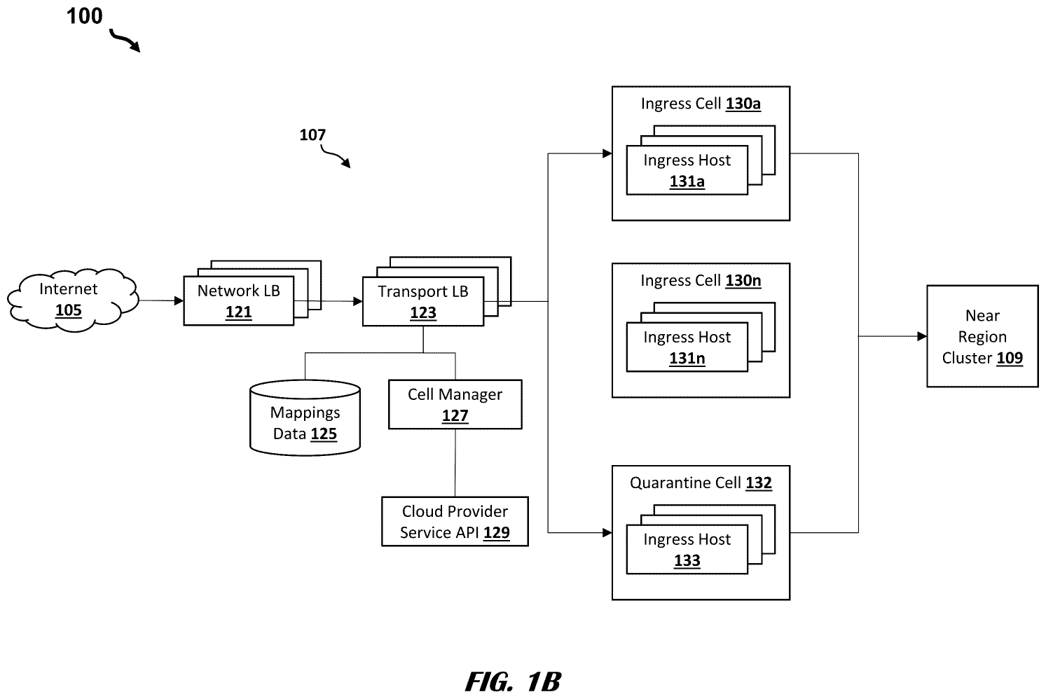

FIGS. 1A-1B show components of an example system 100 for handling data traffic for various computing services and web-based applications in a distributed computing environment. The system 100 includes user devices 103 that access and communicate with the various services offered by and hosted in a service provider system 101 of a service provider. In some embodiments, the provider system 101 is provisioned into and hosted by a cloud infrastructure service system (e.g., Azure®, AWS®). The user devices 103 access and request the various services of the provider system 101 via the Internet 105 or other networks. The network load-balancers 121 and transport load-balancers 123 may proxy or route the data traffic to, for example, prevent a single target resource from being overloaded, mitigate or halting DDOS attacks, and maintain consistent application performance, among other benefits.

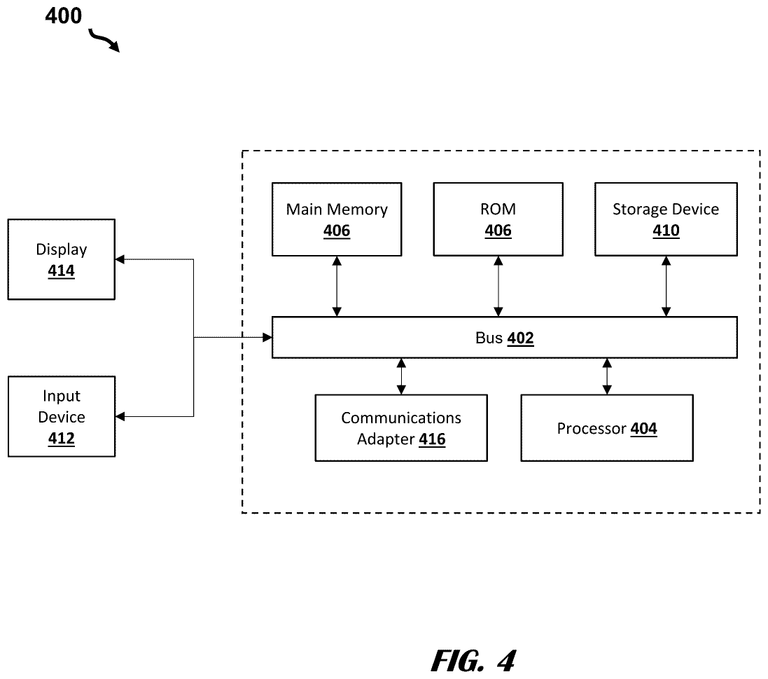

The user devices 103 may be any computing device comprising at least one processor and a non-transitory, machine-readable storage medium capable of performing the various tasks and processes described herein. Non-limiting examples of the user device 103 may be a workstation computer, laptop computer, phone, tablet computer, or server computer. During operation, various end-users may use one or more user devices 103 to access the services hosted in the computing nodes and clusters of the provider system 101. An example embodiment and/or example components of a user device 103, admin device 104, or other types of computing devices of the system 100 may be found in FIG. 4.

The provider system 101 includes an admin device 104 as a particular type of user device 103 having at least one processor that executes software programming of an administrative operator software tool for managing or configuring the components of the provider system 101. In some configurations, the admin device 104 may include, generate, or otherwise display a graphical user interface that presents telemetry information related to, for example, the user devices 103, source identifiers of data traffic, destination domains, and computing services, among other types of information for filtering or reviewing the telemetry of the user data traffic as observed. The administrative operator tool of the admin device 104 receives configuration inputs from an administrative user including configuration instructions or configuration data. The administrative operator tool stores the various configuration inputs and/or configuration data into non-transitory machine-readable storage accessible to the admin device 104. In some cases, the administrative operator tool of the admin device 104 transmits certain configuration instructions and/or configuration data to various components of the provider system 101.

The provider system 101 includes hardware and software computing resources of the service provider. The provider system 101 may be logically and/or physically distributed into clusters. The clusters include sets of computing resources, such as servers or virtual machines, including hardware and software components for performing operations of certain computing services hosted by the hardware and software of the provider system 101.

As an example, in the system 100 depicted in FIG. 1A, the provider system 101 comprises geographical clusters, including any number of far region clusters 107a-107n (generally referred to as far region clusters 107 or a far region cluster 107), any number of near region clusters 109a-109n (generally referred to as near region clusters 109 or a near region cluster 109), and one or more main clusters 111. In this example, data traffic from a user device 103 is routed over the Internet 105 to a far region cluster 107 nearby or relative to the geographic location of the user device 103. The hardware and software resources of the far region cluster 107 may perform various operations on the data packets of the data traffic and route the data traffic to a near region cluster 109, in accordance with preconfigured proxying or routing instructions. Likewise, the hardware and software computing resources of the near region cluster 109 may perform various operations on the data packets of the data traffic and route the data traffic to a main cluster 111, also in accordance with preconfigured proxying or routing instructions. Outbound communication to the user device 103 flows in a similar manner, from the main cluster 111 executing the service requested by the user device 103.

The near-region clusters 109 of the provider system 101 include computing resources for handling data traffic of the user devices 103 over the Internet 105, to and from the far-region clusters 107. A near-region cluster 109 includes hardware and software computing resources that perform additional routing and/or pre-processing functions, such as frontend functions or cluster feed (or “clusterfe”) functions, for the user data traffic of the user devices 103. The components of the near-region clusters 109 route the user data traffic, which include requests or data for computing services hosted and executed by the computing resources of the main clusters 111 of the provider system 101.

The main cluster 111 of the provider system 101 include the computing resources for hosting and executing the computing services in accordance with the user data traffic. The main cluster 111 includes, for example, a non-transitory machine-readable storage and a server or at least one processor for executing the computing services and responding to the requests from the user devices 103. The far-region cluster 107 routes the user data traffic to main servers of the main clusters 111 that execute the requests for computing services indicated by the user data traffic from the user devices 103. Optionally, the far-region cluster 107 routes the user data traffic to the near-region cluster 109, which in turn, routes the user data traffic to the main servers of the main clusters 111 to execute the requests for computing services. The main server of the main cluster 111 executes the requested computing service, in accordance with the input instructions or input data of the request from the user device 103. The main server of the main cluster 111 generates various outputs containing the output results, output instructions, or output data and transmits the output(s) in outbound user data traffic to the user device 103, via the ingress cells 130, far-region clusters 107, and/or near-region clusters 109.

FIG. 1B shows data flow amongst components of the system 100 at a far-region cluster 107 of the provider system 101 handling data traffic of a user device 103 over the Internet 105, according to an example embodiment. The far-region cluster 107 includes network load-balancers 121a-121n (generally referred to as network load-balancers 121 or a network load-balancer 121), L4 transport load-balancers 123a-123n (generally referred to as transport load-balancers 123 or a transport load-balancer 123), mappings database 125, a cell manager 127, a cloud service API 129, ingress cells 130a-130n (generally referred to as ingress cells 130 or an ingress cell 130), and one or more ingress quarantine cells 132. The ingress cells 130 include ingress hosts 131 and the ingress quarantine cells 132 include quarantine ingress hosts 133.

The ingress cells 130 include logical and physical points of entry or gateways for the user data traffic from the user devices 103, such as the requests for the computing services or data updates, to enter and access the computing services hosted and executed by the provider system 101. In some cases, the ingress cells 130 generally function as the initial points of contact for the user data traffic and may include software and hardware functions for routing, at layer 7, and distributing workload across the decentralized infrastructure of the provider system 101. The ingress cells 130 may handle the initial routing of incoming traffic, directing it to the appropriate nodes or resources within the decentralized network of the provider system 101 (or a cloud-hosting service provider system). In some embodiments, the ingress cell hosts 131 of the ingress cells 130 may optionally perform certain load-balancing operations to ensure that the workload is distributed efficiently across components of the provider system 101, such as the ingress cell hosts 131 or other downstream computing resources (e.g., computing resources of the near-region clusters 109; computing resources of the main clusters 111).

Each ingress cell 130 includes one or more ingress cell hosts 131 having hardware and software components capable of performing the various features and functions the ingress cells 130 described herein. In some implementations, an ingress cell host 131 includes, for example, a virtual machine as a software-based application that is provisioned to function as the ingress cell host 131 that may proxy or route data traffic at layer 7 to the request computing service at the main clusters 111. The transport load-balancer 123 proxies or routes the user data traffic, at layer 3 and/or layer 4, to the ingress cell host 131 of the ingress cell 130 to handle the user's request for computing services. Beneficially, the isolations and routing actions at layer 3 and/or layer 4 are performed and imposed by the transport load-balancers 123 to implement the shuffle sharding arrangement, yet the routing actions at layer 3 and/or layer 4 remain transparent to the ingress hosts 131 or quarantine ingress hosts 133, which are instantiated in virtualized computing resources (e.g., a layer 7 virtual machine application) in the ingress cells 130 or quarantine ingress cells 132. In some prior approaches, telemetry information, such as information or metadata for the user data traffic or the routing actions at layer 3 and/or layer 4, may be lost, discarded, or otherwise unavailable to the service provider. In embodiments, however, the transport load-balancer 123 may generate and store telemetry information based upon or indicating, for example, metadata of the data packets of the user data traffic and the routing actions performed by the transport load-balancer 123 or other devices at layer 3 and/or layer 4.

Optionally, in some configurations, the transport load-balancers 123, ingress cells 130, and/or the ingress cell hosts 131 may include software functions for security and isolations, such as firewalls, access controls, and authentication mechanisms to protect against unauthorized access and enforce isolation, which may mitigate against security vulnerabilities or DDOS attacks.

The mapping database 125 includes any form of non-transitory machine-readable storage capable of storing or updating the mapping data. The mapping data indicates, for example, the mappings or associations between the computing services, ingress cells 130, destination domains, and/or user devices 103, among other types of mapping data that the transport load-balancers 123 may reference for proxying or routing the user data traffic. In some embodiments, the mappings database 125 includes a machine-readable computer file containing the mappings data. In some embodiments, the mappings database 125 is hosted in non-transitory machine-readable storage media of one or more computing devices or otherwise within the computing resources provisioned to the architecture of the provider system 101. In operation, the cell manager(s) 127 and/or the transport load-balancer(s) 123 may update or query the mappings data of the mappings database 125, when new services are onboarded or when establishing a TCP connection (or other type of L4 transport layer connection with the user device 103) to handle data traffic of the user devices 103.

As an example, the mapping data may indicate mappings between domain names and ingress cells 130. In this example, when a new computing service is onboarded, the cell manager 127 or the mappings database 125 generates the mapping between the domain name pointing to the new computing service and the ingress host cells 130 for the computing resources hosting the new computing service. In some embodiments, the cell manager 127 (or other component of the provider system 101) assigns each domain name to two random ingress host cells ingress cell 130. The ingress cells 130 include computing devices or resources, as ingress hosts 131, that maintain isolation while forwarding requests to the nodes or hosts within a near-region cluster 109 of the provider system 101.

The cell manager 127 includes software components (e.g., APIs, gRPC code instructions, REST code instructions) executed on one or more computing devices of the provider system 101, where the code of the cell manager 127 may manage and perform various types of routing or administrative functions. As an example, the cell manager 127 may perform certain functions for onboarding new computing services and implementing isolation of the ingress cells 130 amongst the computing resources of the provider system 101, in accordance with the shuffle sharding architecture.

As another example, the cell manager 127 may query or gather various types of information associated with, for example, the computing services, ingress cells 130, destination domains, and/or user devices 103, among other types of information that the transport load-balancers 123 may use for routing the user data traffic to the assigned ingress cells 130. For instance, the cell manager 127 may receive a query for mapping data or routing instructions from the transport load-balancer 123 or other device of the provider system 101. In some cases, the cell manager 127 may receive a query for, or otherwise perform, a health check to determine health check information for an ingress cell 130 indicated in the mapping data retrieved from the mappings database 125. The cell manager 127 may transmits queries or polls the particular ingress cell(s) 130 for the health check information, where the cell manager 127 may receive the mapping data and/or the health check information from the ingress cell 130 or the mappings database 125. The cell manager 127 then responds to the transport load-balancer 123. In responding, the cell manager 127 transmits, for example, the destination domain, the ingress cell 130 associated with the requested service or destination domain, and/or the health check information for the ingress cell(s) 130, among other types of information.

The network load-balancers 121 may handle the routing of the user data traffic, directing the user data packets to the nodes or resources within the decentralized network of the provider system 101. The network load-balancers 121 may be responsible for load balancing to ensure that the workload is distributed efficiently across the network. The network load-balancers 121 include hardware and software components for routing data traffic according to layer 3 protocols (e.g., Internet Protocol (IP)) and/or layer 4 protocols (e.g., Transmission Control Protocol (TCP), User Datagram Protocol (UDP), Transport Layer Security (TLS)) using the corresponding types of header data of the data packets of the user data traffic. A network load-balancer 121 typically distributes the network traffic across multiple destination or target components of the provider system 101, such as virtual machine instances, containers, and IP addresses within the provider system 101. The network load-balancer 121 of the far-region cluster 107 may proxy and forward requests in the user data traffic to a transport load-balancer 123. The network load-balancers 121 function as a point of contact for the user devices 103. A user device 103 may send data traffic containing requests to a domain name or IP address associated with the provider system 101, the network load-balancer 121, or other component of the provider system 101. The network load-balancer 121 may distribute the requests from the user devices 103 amongst one or more destination domains or other resources within the provider system 101.

The transport load-balancers 123 include hardware and software components for routing data traffic according to layer 4 (e.g., TCP, UDP) header data in the data packets of the user data traffic and mapping data of the mapping database 125. In some cases, the transport load-balancers 123 may perform routing functions for the user data traffic, directing the user data packets to the appropriate nodes or resources within the decentralized network of the provider system 101. The transport load-balancers 123 may also perform functions for load balancing to ensure that the workload is distributed efficiently across the provider system 101. A host or node of the transport load-balancers 123 includes software resources (e.g., virtual machine) executed on hardware resources (e.g., at least one processor, server, non-transitory storage media).

The hosts of the transport load-balancers 123 includes software functions that implement logic and functions of the shuffle sharding to enforce shuffle sharding isolations in the provider system 101. A transport load-balancer 123 may proxy and forward the request in the data traffic to a particular ingress host cell 130 or quarantine ingress cell 132. An ingress cell 130 includes any number of cells or shards, which are a single unit of an ingress host collection. Embodiments may include any number of ingress cells 130 available to the transport load-balancer(s) 123 when proxying and routing data traffic to the ingress cells 130.

When the user device 103 is establishing a new TCP/IP connection with the provider system 101, the user device 103 transmits a TLS handshake Client Hello packet or similar types of handshake data packets to the network load-balancer 121 and the transport load-balancer 123. The transport load-balancer 123 inspects the header data of the data packet of the handshake packet to identify a destination domain associated with the computing service requested by the data traffic. In some cases, the transport load-balancer 123 determines the destination domain of the user data traffic based upon a Service Name Indication (SNI) in the header data of the TLS handshake packet. The SNI contains the destination domain of the computing service that the user device 106 is attempting to access.

In some embodiments, the transport load-balancer 123 or other component of the provider system 101 (e.g., the network load-balancer 121) determine the destination domain using the SNI or other layer 3 or layer 4 identifier (e.g., domain name) in the data packets of the user data traffic. The transport load-balancer 123 (or other component of the provider system 101) determines the identifier (e.g., SNI, domain name) of the data packet of the user traffic and queries a DNS server or other computing service (e.g., Route53®) to determine the destination domain of the computing service as requested by the user device 103.

The transport load-balancer 123 may query the mapping data in the mapping database 125 to determine the ingress cells 130 that handle data traffic for the destination domain. Optionally, the transport load-balancer 123 queries the mapping data to perform the health check of the ingress cells 130. In some cases, the mapping of the destination domain names to the ingress cells 130 are gathered or generated by software operations of the transport load-balancer 123 or the mapping database 125, or indicated by administrative user inputs from the admin device 104. For example, the transport load-balancer 123 may query or instruct the cell manager 127 software program to indicate or determine mapping data and/or health status information for instances of ingress cells 130. The cell manager 127 may poll or query the resources of the instances of the ingress cells 130 to determine the health status information and/or the mapping data. The cell manager 127 may return the mapping data and/or the health status information to the transport load-balancer 123. Additionally or alternatively, The cell manager 127 may return the mapping data and/or the health status information to the mapping database 125.

As an example, the transport load-balancer 123 queries a mapping of destination domain names to the ingress cell hosts 131. The cell manager 127 may gather the mappings of the destination domains to the ingress cell host 131 via a cloud-service API 129 to query or poll the health check information. In some cases, the cell manager 127 of the transport load-balancer 123 periodically calls or invokes the executable code of the cloud-service API 129. Each particular ingress cell 130 is associated with metadata or tags, which may be generated or stored by the cell manager 127 or other software administrative component (e.g., administrative operator tool of the admin device 104) of the provider system 101 during the onboarding process for new computing services or newly provisioned computing resources (e.g., ingress cells 130). To figure out the ingress cell hosts 131, cell manager 127 calls the cloud-service API 129 to identify or determine the metadata values or tags of the ingress cell 130 and may store the metadata or tags into non-transitory memory (e.g., database). In some cases, the cell manager 127 or the cloud-service API 129 may append or add additional metadata tags for the ingress cell 130 in the mappings database 125 or other non-transitory storage of the provider system 101. In some implementations, for each ingress cell 130, the transport load-balancer 123 executes a cloud-service API 129 for an individual health check routine (e.g., traffic volume, traffic throughput, resource status) of a particular computing service or particular ingress cell 130. The transport load-balancer 123 may route the user data traffic to a particular ingress cell 130 according to the destination domain and health check information. For instance, the transport load-balancer 123 may route the user data traffic to an alternative ingress cell 130 for the destination domain, as a failover or workload-balance using the health check information.

The transport load-balancer 123 may inject or update the metadata fields of the header data in the data packets of the user data traffic. In operation, the transport load-balancer 123 may read the TLS Client Hello packets for incoming connections, extract the ingress cell 130 or other information from the SNI extension data, select an upstream ingress host 130, and establish a TLS and/or TCP connection to the ingress host 131 of the ingress cell 130. When the transport load-balancer 123 establishes the upstream connection to the ingress cell 130, the transport load-balancer 123 may inject or update proxy metadata to direct or route the data packets. For example, the transport load-balancer 123 may inject a Proxy Protocol V2 (PPV2) header into the data packet(s) of the user traffic data to indicate the client's IP to the cell manager 127 or an administrative ingress controller software, among other types of administrative software programs of the provider system 101.

The transport load-balancer 123 may further capture or generate telemetry information for a given data traffic stream, using various types of metadata of the data packets in the data traffic. The transport load-balancer 123 may store the telemetry information into one or more databases or non-transitory machine-readable storage media. In some cases, a virtual machine, server, or administrative software of an admin device 104 may reference the telemetry information and configure the transport load-balancer 123 or other components of the system 100 using the telemetry information. In some cases, a server may execute software programming that references the telemetry information and trains a machine-learning architecture of the software programming to detect or reject data traffic having similar telemetry information.

In some embodiments, the provider system 101 may include one or more default cells or quarantine ingress cells 132 for default or uncertain types of data that may require additional review or consideration before being blocked. For instance, the TLS Client Hello message could be included in multiple data packets of the client data traffic. In such circumstances, the ingress cell 130 or the transport load-balancer 123 may route the requests in the data traffic to a generic or default ingress cell 130 or to a quarantine ingress cell 132 to ensure reliability without fully trusting the data traffic.

Optionally, the provider system 101 may implement TLS Encrypted Client Hello (“ECH”) data packets in the user data traffic. In such cases, the transport load-balancer 123 may be able to decrypt the TLS ECH data packets of the user data traffic, using a secret key paired to a public key transmitted to a user device 103 through the Internet 105 (e.g., via DNS over HTTPS). In some embodiments, the DNS configuration data and transport load-balancer 123 reside in a trusted space of the provider system 101.

The transport load-balancers 123 may mitigate against DDOS attacks by, for example, dropping packets or routing data traffic to the quarantine ingress cells 132. The transport load-balancer 123 implement IP-based banning of IP address in data packets by dropping packets having IP addresses (or related identifiers) in a blocklist. The transport load-balancer 123 may automatically generate and update the blocklist or may generate and update the blocklist in response to user configuration inputs that indicate IP addresses for the blocklist. Additionally or alternatively, the transport load-balancer 123 may also implement JA3-based banning of JA3 fingerprints (or similar device identifying fingerprinting) by dropping the data packets in the user data traffic having metadata values that match expected metadata values of a JA3 fingerprint of a blocklist.

As mentioned, the transport load-balancer 123 may generate, extract, or otherwise capture the telemetry data associated with the data traffic and the user devices 103. The telemetry data may be used for downstream functions to configure proxy or security nodes, and/or train or tune machine-learning architectures for identifying or detecting signatures of attackers or exploit attempts within the metadata of the telemetry data. Oftentimes, the telemetry data is not captured or is otherwise unavailable when implementing layer-3 or layer-4 traffic-blocking features in cloud hosting systems. The transport load-balancer 123, however, has access to the metadata for developing telemetry data and may extract the header data that corresponds to the telemetry data to detect instances in which the telemetry data of an attacker signature or exploit signature stored in a database, matches to the telemetry data of the user data traffic from the user device 103. The transport load-balancer 123 may identify one or more matches in the data values and determines whether the identified satisfy one or more thresholds.

In some implementations, the transport load-balancer 123 may determine one or more scores (e.g., reputation score, risk score) associated with the user data traffic using the telemetry information. The transport load-balancer 123 then routes the user data traffic according to the score(s). The transport load-balancer 123 (or other software or hardware component of the system 100) stores the telemetry data for user data traffic containing attacks, exploits, or genuine user communications into one or more databases. The transport load-balancer 123 may generate and reference the telemetry data as signatures or patterns of telemetry data. The transport load-balancer 123 may automatically identify or detect an instance that the user data traffic likely includes the telemetry data of an exploit or attack. The transport load-balancer 123 may compute the scores based on one or more values indicating similarities or differences between the telemetry information of certain user data traffic and the telemetry data of an attacker or exploit signature. Additionally or alternatively, the transport load-balancer 123 may receive configuration inputs or requests indicating that certain telemetry data indicates a particular attacker signature or exploit signature. The transport load-balancer 123 (or other device of the system) may store this telemetry data and compare this telemetry data against the telemetry data of the user data traffic from the user device 103 to detect one or more matches, and whether the matches satisfy one or more thresholds.

In some configurations, the transport load-balancer 123 drops the user data packets or rejects the user data traffic from the user device 103 in response to determining that the telemetry data of the user data traffic of the user device 103 satisfies one or more detection threshold values.

In some circumstances, the transport load-balancer 123 determines that the user data traffic or the user device 103 is suspicious or malicious, in response to the transport load-balancer 123 determining that the one or more scores computed for the telemetry data of the user device 103 satisfies one or more risk threshold values. In a configuration, the transport load-balancer 123 or provider system 101 automatically drops or rejects the data packets of the user data traffic of the user device 103 in response to detecting the suspicious user data traffic. Alternatively, in a configuration, the transport load-balancer 123 directs or routes the suspicious user data traffic to a quarantine cell host 133 of a quarantine ingress cell 132, in response to detecting the suspicious user data traffic.

The quarantine cell host 133 of the quarantine ingress cell 132 includes software and hardware computing resources (e.g., virtual machine executed by at least one processor of the system 100), similar to an ingress cell host 131 of an ingress cell 130. However, the characteristics and configurations of the quarantine ingress cell 132 and quarantine cell host 133 may, for example, mitigate or slowdown the growth of the attacker or malicious traffic (e.g., DDOS attack in user data traffic). As an example, the quarantine ingress cell 132 are provisioned relatively fewer or smaller computing resources compared to the ingress cells 130, such that the quarantine cell hosts 133 are comparatively slower than the ingress cell hosts 131. In this way, the ingress cell hosts 131 may slow down the pace of a DDOS attack because the ingress cell hosts 131 function slower than the ingress cell hosts 131. As another example, the quarantine ingress cell 132 and quarantine cell host 133 are configured to implement lower timeouts compared to the ingress cells 130 and the ingress cell hosts 131. In this way, the quarantine ingress cell 132 and quarantine ingress hosts 133 operate comparatively slower or less efficiently than the ingress cells 130, which mitigates against the advance or spread of DDOS attacks.

In some embodiments, the transport load-balancer 123 can generate an instruction or gather and analyze header data in the data packets to classify the user data traffic as suspicious, malicious, or the like, based on identifying one or more predetermined identifiers in the data packets (e.g., domain, IP, JA3 signature). The transport load-balancer 123 may route the data traffic to a quarantine ingress cell 132 comprising the quarantine cell host 133 having software programming configured to dampen the suspicious user traffic. Additionally or alternatively, the transport load-balancer 123 may receive an administrative user input from the administrative operator software tool executed by the administrative device 104 to classify the user data traffic as suspicious, malicious, or the like. The transport load-balancer 123 may route the data traffic to the quarantine cell host 133 of the quarantine ingress cell 132 having the software programming configured to dampen the suspicious user traffic.

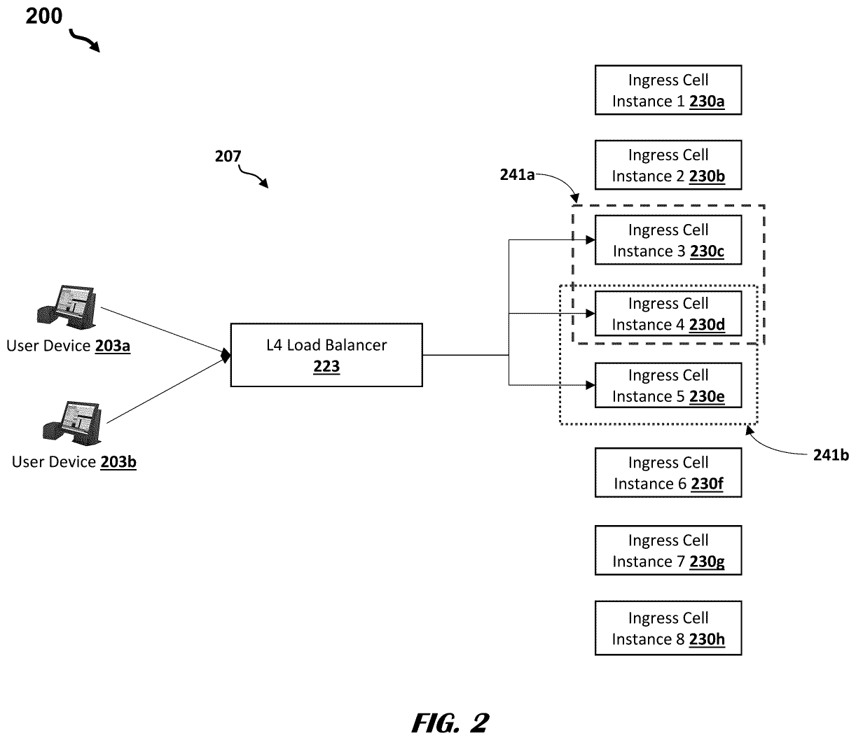

FIG. 2 shows data flow amongst components of a provider system 200 implementing shuffle sharding at an edge of the provider system 200, according to an embodiment. The system 200 includes user devices 203a-203b (generally, a user device 203 or user devices 203) that communicate via one or more networks with components of a near-region cluster 207. The near-region cluster 207 includes, for example, network load balancers (e.g., network load balancers 121 in FIG. 1B), transport L4 load balancers 223, and ingress cell instances 230a-230h (generally, ingress cell instances 230 or an ingress cell instance 230) containing or communicating with provisioned resource instances.

The provider system 200 includes hardware and software components that host and execute web-based computing services accessed by the user devices 203. A cell manager (e.g., cell manager 127 in FIG. 1B) or other computing resource of the system 200 may provision computing resources as ingress cell instances 230 that are dedicated and isolated to certain computing services, and isolated between user data traffic.

The network load balancers include hardware and software components for communicating user data traffic information, at layer 3 and/or layer 4, to and from the user devices 203. A network load balancer may proxy or route the data packets of the user data traffic to a transport load-balancer 223.

Additionally or alternatively, the transport load balancer 223 may proxy and route the user data traffic to the ingress cells 230, functioning at layer 4 (and, in some cases, layer 3) to direct the data packets. The software programming of the transport load balancer 223 instructs the transport load balancer 223 on proxying and routing the data packets of the user devices 203 according to ingress cell instances 230 assigned to the services requested by the data traffic.

A software component of the system 200, such as a cell manager (e.g., cell manager 127) or other administrative program, may shard or isolate the provider system 200 architecture into cells. The administrative program may randomly assign a set of one or more assigned cells 241, containing one or more overlapping cells assigned to individual computing services of the provider system 200. The isolated ingress cell instances 230 create isolations in a multi-tenant architecture to reduce impact of one computing service on another computing service.

As an example, the system 200 depicted in FIG. 2 includes eight ingress cell instances 230a-230h, and the administrative program assigns two cells 230 per computing service accessible to the user devices 203. In this example, the administrative program assigns two cells (e.g., ingress cell instance no. 3 230c, ingress cell instance no. 4 230d) as a first set of assigned cells 241a; and assigns two cells (e.g., ingress cell instance no. 4 230d; ingress cell instance no. 5 230e) as a second set of assigned cells 241b. When a first user device 203a accesses or requests the computing services assigned and hosted to the first set of assigned cells 241a, then the L4 transport load-balancer 223 routes the first data traffic to the ingress cell instance no. 3 230c or the ingress cell instance no. 4 230d. Similarity, when a second user device 203b accesses or requests the computing services assigned and hosted to the second set of assigned cells 241b, then the L4 transport load-balancer 223 routes the second data traffic to the ingress cell instance no. 4 230e or the ingress cell instance no. 5 230e.

To implement this architecture for shuffle sharding and random assignments, the administrative program or other computing program may label or assign cell identifiers (Cell IDs) to corresponding ingress cell instances 230. For instance, the administrative program randomly assigns the two ingress cell instances 230, as the set assigned cells 241, to a computing service of the provider system 200. As mentioned, the L4 transport load-balancer 223 is, in part, defined by various software functions that, when executed by provisioned hardware hosting components (e.g., at least one processor), may perform various functions of a frontend gateway or entry point to the provider system 200 from the user devices 203. The L4 transport load-balancer 223 receives user data traffic containing requests for computing services of the provider system 200 and routes the data traffic containing the request to the relevant ingress cell instance 230 assigned to the requested computing service. The LA transport load-balancer 223 determines the Cell ID assigned to the user traffic using stored mapping data, which indicates the Cell ID assigned to, for example, a domain name or IP address, or other types of layer 3 and/or layer 4 identifiers of the computing service requested by the user data traffic of the user device 203.

As an example, the data traffic of the first user device 203a includes a request for a computing service assigned to the first set of assigned cells 241a, including the third ingress cell instance 230c and the fourth ingress cell instance 230d. The LA transport load-balancer 223 identifies a destination domain for the computing resources (e.g., servers, webserver software) that host the requested computing service of the first user device 203a. The L4 transport load-balancer 223, for example, identifies an SNI value of the requested computing service using the data packets of the user data traffic and determines the destination domain from the SNI in the user traffic from the first user device 203a. The L4 transport load-balancer 223 then routes the data traffic of the first user device 203a to the first set of assigned cells 241a assigned to the computing service requested by the first user device 203a.

Continuing with this example, the data traffic of the second user device 203b includes a request for a computing service assigned to the second set of assigned cells 241b, including the fourth ingress cell instance 230d and the fifth ingress cell instance 230e. The L4 transport load-balancer 223 identifies a destination domain for the computing resources (e.g., servers, webserver software) that host the requested computing service of the second user device 203b. The L4 transport load-balancer 223, for example, identifies an SNI value of the requested computing service using the data packets of the user data traffic and determines the destination domain from the SNI in the user traffic from the second user device 203b. The L4 transport load-balancer 223 then routes the data traffic of the second user device 203b to the second set of assigned cells 241b assigned to the computing service requested by the second user device 203b.

The L4 transport load-balancer 223 may route the user data traffic to the ingress cell instances 230 to maintain isolation and mitigate the impact of DDOS attacks. For example, if a DDOS attack targets the first computing service, then the L4 transport load-balancer 223 directs the malicious data traffic to the first set of assigned cells 241a. The DDOS attack might overwhelm the computing resources of the third ingress cell instance 230c and fourth ingress cell instance 230d and disrupt the first computing service, yet the L4 transport load-balancer 223 routes the data traffic for the second computing service to the second set of assigned cells 241b. Even if the fourth ingress cell instance 230d is disrupted by the DDOS attack that targeted the first computing service, the computing resources of the fifth ingress cell instance 230e may continue hosting and servicing the second computing service on behalf of the second user device 203b, because the L4 transport load-balancer 223 does not route the data traffic containing the DDOS attack traffic to the isolated, second set of assigned cells 241b.

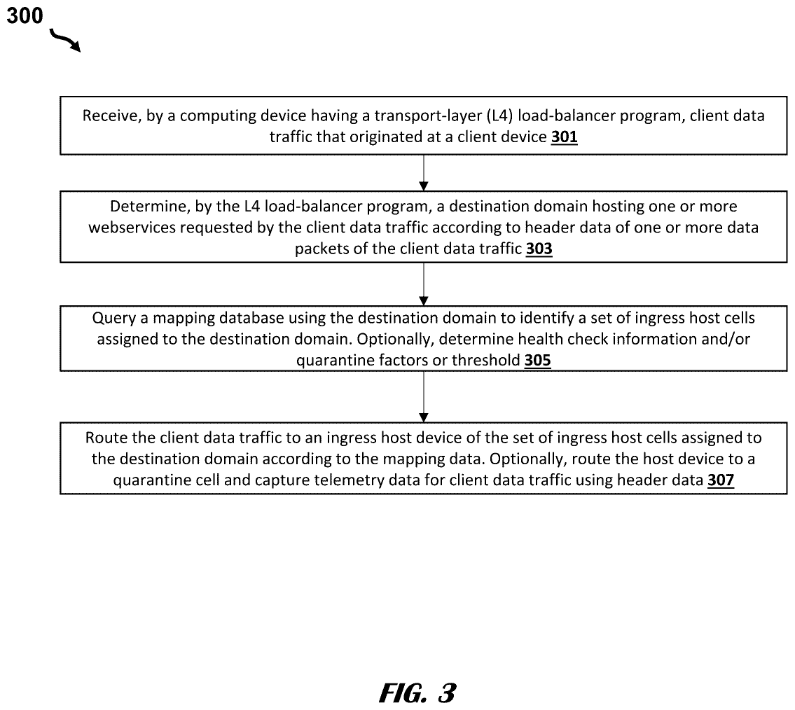

FIG. 3 shows operations of a method 300 for handling user data traffic in a distributed computing environment of a provider system implementing shuffle sharding, according to an example embodiment. Embodiments may include additional, fewer, or different operations from those described in the method 300. The method 300 may be performed by one or more computing devices executing machine-readable software code for hosting a transport-layer (L4) load-balancer program, though it should be appreciated that the various operations may be performed by at least one processor of a computing device.

In operation 301, the computing device hosting the transport-layer (L4) load-balancer program receives user data traffic that originated at a client device. The provider system may receive the user data traffic from the user device via a layer 3 and/or layer 4 network load-balancer hosted on software components of one or more computing devices. The network load-balancer obtains the data traffic through the Internet from the user device. In operation 303, the L4 load-balancer determines a destination domain hosting one or more webservices requested by the client data traffic according to header data of one or more data packets of the client data traffic.

In operation 305, the L4 load-balancer (or other hardware or software components of system) queries a mapping database using the destination domain to identify a set of ingress host cells assigned to the destination domain. Optionally, the L4 load-balancer determines health check information and/or quarantine factors or threshold.

In operation 307, the L4 load-balancer (or other hardware or software components of system) proxies or routes the client data traffic to an ingress host device of the set of ingress host cells assigned to the destination domain according to the mapping data. Optionally, the L4 load-balancer (or other hardware or software components of system) proxies or routes the host device to a quarantine cell and capture telemetry data for client data traffic using header data.

FIG. 4 is a component diagram of an example computing system 400 suitable for use in the various implementations described herein, according to an example embodiment. One or more steps of the methods and processes discussed herein can be performed by the computing system 400 depicted in FIG. 4. The computing system 400 includes a bus 402 or other communication component for communicating information and a processor 404 coupled to the bus 402 for processing information. The computing system 400 also includes main memory 406, such as a RAM or other dynamic storage device, coupled to the bus 402 for storing information, and instructions to be executed by the processor 404. Main memory 406 can also be used for storing position information, temporary variables, or other intermediate information during the execution of instructions by the processor 404. The computing system 400 may further include a ROM 408 or other static storage device coupled to the bus 402 for storing static information and instructions for the processor 404. A storage device 405, such as a solid-state device, magnetic disk, or optical disk, is coupled to the bus 402 for persistently storing information and instructions.

The computing system 400 may be coupled via the bus 402 to a display 414, such as a liquid crystal display, or active-matrix display, for displaying information to a user. An input device 412, such as a keyboard including alphanumeric and other keys, may be coupled to the bus 402 for communicating information, and command selections to the processor 404. In another implementation, the input device 412 has a touchscreen display. The input device 412 can include any type of biometric sensor, or a cursor control, such as a mouse, a trackball, or cursor direction keys, for communicating direction information and command selections to the processor 404 and for controlling cursor movement on the display 414.

In some implementations, the computing system 400 may include a communications adapter 416, such as a networking adapter. Communications adapter 416 may be coupled to bus 402 and may be configured to enable communications with a computing or communications network or other computing systems. In various illustrative implementations, any type of networking configuration may be achieved using communications adapter 416, such as wired (e.g., via Ethernet), wireless (e.g., via Wi-Fi, Bluetooth), satellite (e.g., via GPS) preconfigured, ad-hoc, LAN, WAN, and the like.

According to various implementations, the processes of the illustrative implementations that are described herein can be achieved by the computing system 400 in response to the processor 404 executing an implementation of instructions contained in main memory 406. Such instructions can be read into main memory 406 from another computer-readable medium, such as the storage device 410. Execution of the implementation of instructions contained in main memory 406 causes the computing system 400 to perform the illustrative processes described herein. One or more processors in a multi-processing implementation may also be employed to execute the instructions contained in the main memory 406. In alternative implementations, hard-wired circuitry may be used in place of or in combination with software instructions to implement illustrative implementations. Thus, implementations are not limited to any specific combination of hardware circuitry and software.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, attributes, or memory contents. Information, arguments, attributes, data, etc. may be passed, forwarded, or transmitted via any suitable means including memory sharing, message passing, token passing, network transmission, etc.

The actual software code or specialized control hardware used to implement these systems and methods is not limiting of the invention. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-Ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A computer-implemented method for managing data traffic, the method comprising:
receiving, by a computer executing a load-balancer program, client data traffic comprising one or more data packets that originated at a client device;
determining, by the computer, a destination domain hosting one or more webservices requested by the client data traffic according to header data of the one or more data packets;
querying, by the computer, a mapping database using the destination domain to identify a set of ingress host cells assigned to the destination domain, the mapping database containing mapping data indicating a plurality of mappings between a plurality of domains to a plurality of sets of ingress host cells; and
routing, by the computer, the one or more data packets of the data traffic to an ingress host of the set of ingress host cells assigned to the destination domain according to the mapping data.

2. The method according to claim 1, wherein each ingress host of each ingress host cell routes the data traffic to the destination domain.

3. The method according to claim 1, further comprising establishing, by the computer, a transport-layer connection for the client device to the ingress host of the sets of ingress host cells according to the mapping data.

4. The method according to claim 1, further comprising updating, by the computer, one or more header fields of at least one data packet of the client data traffic for routing the client data traffic to the ingress host and to the destination domain.

5. The method according to claim 1, further comprising determining, by the computer, health check information for each ingress host cell assigned to the destination domain using the mapping database.

6. The method according to claim 5, further comprising:
querying, by the computer, a cell manager program that polls each instance of the ingress host cells associated with the destination domain; and
receiving, by the computer, the health check information from the cell manager program.

7. The method according to claim 1, further comprising:
assigning, by the computer, the one or more webservices of the destination domain to at least one ingress cell during an onboarding process; and
updating, by the computer, the mapping database to indicate that the one or more webservices are mapped to the at least one ingress cell.

8. The method according to claim 1, further comprising determining, by the computer, a service name indicator (SNI) in the header data of at least one data packet of the client data traffic, the SNI indicating the destination domain of the client data traffic.

9. The method according to claim 1, wherein the set of ingress host cells assigned to the destination domain includes a set of quarantine ingress cells, and wherein the computer routes the client data traffic to the set of quarantine ingress cells in response to the computer determining that the client data traffic satisfies one or more quarantine thresholds.

10. The method according to claim 9, further comprising obtaining, by the computer, packet telemetry data for the client data traffic using the header data of the one or more data packets of the client data traffic.

11. A system for managing data traffic, the system comprising:
a mapping database comprising non-transitory machine-readable storage media, configured to store mapping data indicating a plurality of mappings between a plurality of domains to a plurality of sets of ingress host cells; and
a computing device comprising at least one processor and a load-balancer program, the computing device configured to:
receive client data traffic comprising one or more data packets that originated at a client device;
determine a destination domain hosting one or more webservices requested by the client data traffic according to header data of the one or more data packets;
query the mapping database using the destination domain to identify a set of ingress host cells assigned to the destination domain; and
route the one or more data packets of the data traffic to an ingress host of the set of ingress host cells assigned to the destination domain according to the mapping data.

12. The system according to claim 11, wherein each ingress host of each ingress host cell routes the data traffic to the destination domain.

13. The system according to claim 11, wherein the computing device is further configured to establish a transport-layer connection for the client device to the ingress host of the sets of ingress host cells according to the mapping data.

14. The system according to claim 11, wherein the computing device is further configured to update one or more header fields of the header data of at least one data packet of the client data traffic for routing the client data traffic to the ingress host and to the destination domain.

15. The system according to claim 11, wherein the computing device is further configured to determine health check information for each ingress host cell assigned to the destination domain using the mapping database.

16. The system according to claim 15, wherein the computing device is further configured to:
query a cell manager program that polls each instance of the ingress host cells associated with the destination domain; and
receive the health check information from the cell manager program.

17. The system according to claim 11, wherein the computing device is further configured to:
assign the one or more webservices of the destination domain to at least one ingress cell during an onboarding process; and
update the mapping database to indicate that the one or more webservices are mapped to the at least one ingress cell.

18. The system according to claim 11, wherein the computing device is further configured to determine a service name indicator (SNI) in the header data of at least one data packet of the client data traffic, the SNI indicating the destination domain of the client data traffic.

19. The system according to claim 11, wherein the set of ingress host cells assigned to the destination domain includes a set of quarantine ingress cells, and wherein the computer routes the client data traffic to the set of quarantine ingress cells in response to the computer determining that the client data traffic satisfies one or more quarantine thresholds.

20. The system according to claim 19, wherein the computing device is further configured to obtain packet telemetry data for the client data traffic using the header data of the one or more data packets of the client data traffic.
